(19) United States
(12) Patent Application Publication
(10) Pub. No.: US 2015/0035192 A1
(43) Pub. Date: Feb. 5, 2015

(54) POROUS CERAMIC AND METHOD OF MAKING

(71) Applicant: University of North Dakota, Grand Forks, ND (US)

(72) Inventor: Surojit Gupta, Grand Forks, ND (US)

(21) Appl. No.: 13/957,110

(22) Filed: Aug. 1, 2013

(51) Int. Cl. C04B 38/06

(52) U.S. Cl. CPC C04B 38/061
USPC 264/44

(57) ABSTRACT

A method for forming a porous ceramic includes forming a mixture having at least one ceramic precursor and at least one pore-forming material and heating the mixture to oxidize the ceramic precursor and vaporize the pore-forming material.

### BACKGROUND

Porous ceramics can be used for many different applications. Particular applications include filtration of molten metals or particulates from exhaust gases, radiant burners, catalyst supports, biomedical devices, kiln furniture, reinforcement for metal and polymer matrix composites, bioreactors, solid oxide fuel cells, electrodes, heat exchangers, biological scaffolds and other filtration and insulation applications.

Porous ceramics are generally manufactured by replication of a sacrificial foam template. In this method, a flexible polymeric sponge is impregnated with a ceramic slurry. Excess slip is removed by physical pressure (squeezing) or centrifugation. The impregnated sponge is dried, a subsequent burn-out step eliminates the polymer template, and the remaining ceramic material is sintered at high temperature. The polymeric sponge is typically made of polyurethane, but polyvinyl chloride, polystyrene, cellulose and latex have also been used or tested.

Other porous ceramic manufacturing methods are currently in development. One of these methods involves direct foaming of a liquid slurry. Gas bubbles are generated within a liquid slurry containing ceramic powders or a ceramic precursor solution to create a foam. The foam is set so that it maintains its porosity and the foam is then heated to a high temperature for sintering/ceramization. Another method in development involves burn-out of fugitive pore formers. In this method, hollow cells are produced by the burn-out of solid material such as starch, wax, polymeric beads (e.g., polymethyl methacrylate, polystyrene, polyvinyl chloride), carbon black and sawdust.

Each of the aforementioned methods possesses disadvantages. For the sacrificial foam template and fugitive pore former processes, expansion and gas evolution from the polymer or pore former during heating can lead to the development of internal stresses. Liquid foam stability is an issue for the direct foaming process. Additionally, ceramic slurries are required for most of these methods. The drying of ceramic slurries is a time-consuming and cumbersome process and can lead to internal stresses due to differential shrinkage or gas pressure in the finished ceramic.

### SUMMARY

A method for forming a porous ceramic includes forming a mixture having at least one ceramic precursor and at least one pore-forming material and heating the mixture to oxidize the ceramic precursor and vaporize the pore-forming material.

### BRIEF DESCRIPTION OF THE DRAWINGS

FIGS. 1A-1C are schematic illustrations showing the formation of a porous ceramic according to one embodiment of the present invention.

FIGS. 2A-2D are schematic illustrations showing the formation of a porous ceramic according to another embodiment of the present invention.

FIG. 3A is a schematic representation of a porous ceramic having a metal core and an outer metal oxide layer.

FIG. 3B is a schematic representation of a porous ceramic having a MAX phase core, an intermediate silica layer and an outer metal oxide layer.

FIG. 4 is a graph illustrating oxidation kinetics of a porous ceramic and a control sample.

FIGS. 5A and 5B are graphs illustrating oxidation kinetics and relative density, respectively, of a porous ceramic at varying temperatures and times.

FIG. 6 is an SEM image of a porous ceramic.

FIG. 7 is a graph illustrating porosity and shrinkage of a porous ceramic formed with two pore-forming materials and treated at various temperatures.

FIG. 8 is a graph illustrating porosity and shrinkage of a porous ceramic formed with two pore-forming materials treated at 1450° C. at different time intervals.

FIG. 9 is an SEM image of a porous ceramic formed with two pore-forming materials.

### DETAILED DESCRIPTION

According to the present invention, porous ceramics are formed without using ceramic starting materials, such as ceramic slurries. A porous ceramic is formed by heating a mixture of one or more ceramic precursors and one or more pore-forming materials. First, a mixture of the ceramic precursor and the pore-forming material is made. Then, the mixture is heated to oxidize the ceramic precursor and vaporize the pore-forming material, forming a porous ceramic in the process. The present invention enables the formation of porous ceramics at relatively low temperature and can create porous ceramics having a wide range of porosity and density, without the tedious and time-consuming additional steps needed for methods that use ceramic starting materials. Additionally, unlike other porous ceramic production methods, a highly controlled heating program is not needed to form porous ceramics according to the present invention.

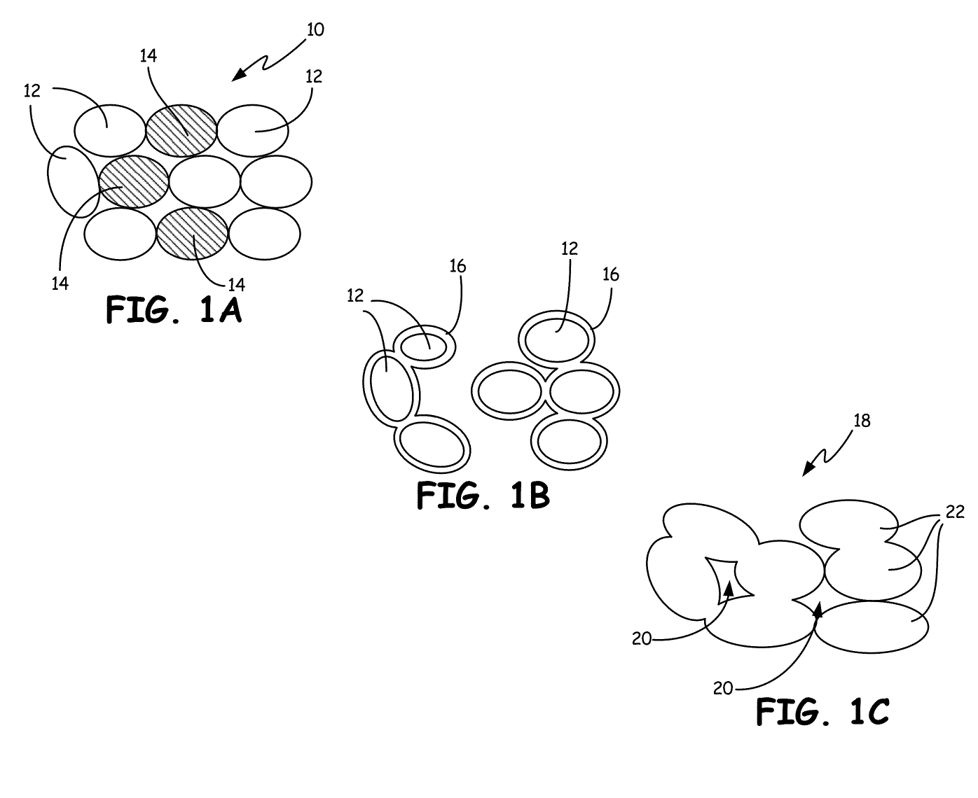

FIGS. 1A-1C schematically illustrate one embodiment of a method for forming a porous ceramic. A mixture of a ceramic precursor and pore-forming material is formed as shown in FIG. 1A. Mixture 10 includes ceramic precursor particles 12 and pore-forming material 14. In some embodiments, mixture 10 is compressed so that ceramic precursors 12 and pore-forming materials 14 are packed together. Mixture 10 is heated to oxidize ceramic precursor 12 and vaporize pore-forming material 14. During heating, the outer surfaces of ceramic precursors 12 begin to oxidize, forming oxide layer 16 on ceramic precursors 12 as shown in FIG. 1B. Additionally, pore-forming materials 14 are removed by vaporization. Once pore-forming materials 14 have been removed, oxygen is able to diffuse through the regions previously occupied by pore-forming materials 14, enabling oxidation of additional ceramic precursor particles 12. As the heating progresses, the oxidation of ceramic precursor 12 becomes substantially complete and ceramic precursor particles 12 rearrange as they are sintered, forming porous ceramic 18 that contains pores 20 and metal oxides 22 as shown in FIG. 1C.

Ceramic precursors suitable for forming porous ceramics according to the present invention include metals, alloys, binary carbides and nitrides, MAX phase compounds and combinations thereof. In some embodiments, ceramic precursors 12 are powders (e.g., metal powders). Suitable metals include, but are not limited to, titanium, vanadium, chromium, iron, cobalt, nickel, copper, zinc, zirconium, niobium, tantalum, hafnium, tungsten, aluminum and silicon. For the purposes of this patent application, silicon is considered a metal. Suitable alloys include, but are not limited to, alloys of titanium, vanadium, chromium, iron, cobalt, nickel, copper, zinc, zirconium, niobium, tantalum, hafnium, tungsten, aluminum, silicon and combinations thereof. Suitable binary carbides include, but are not limited to, TiC, SiC, TaC and ZrC. Suitable binary nitrides include, but are not limited to, TiN and Si₃N₄. MAX phase compounds are layered, hexagonal carbides and nitrides that have the general formula: Mₙ₊₁AXₙ, where n=1 to 3, M is an early transition metal, A is an A-group element (mostly IIIA and IVA, or groups 13 and 14) and X is either carbon and/or nitrogen. Suitable MAX phase compounds include, but are not limited to, Ti₃SiC₂, Ti₂AlC, Cr₂AlC, V₂AlC, Ti₂AlN, Nb₂AlC and Ti₄AlN₃. In one particular embodiment, a combination of titanium powder and nickel powder are used together as the ceramic precursor.

Pore-forming materials suitable for forming porous ceramics according to the present invention include graphite, molybdenum oxides (for example, MoO₃), polymers that decompose or oxidize to form one or more gases at temperatures above 200° C. and combinations thereof. Graphite oxidizes to form CO₂ and vaporizes above about 800° C. Molybdenum oxides MoO₂ and MoO₃ sublime above about 1100° C. and about 1155° C., respectively. One example of a suitable polymer is polyethylene (PE). Depending on its density, PE generally melts at temperatures between about 105° C. and about 135° C. and has a flash point (i.e. vaporizes) between about 320° C. and about 350° C. In one particular embodiment, a combination of PE and graphite are used together as the pore-forming material.

As shown in FIG. 1A, mixture 10 of ceramic precursor 12 and pore-forming material 14 is formed. Mixture 10 can include a wide concentration of ceramic precursor 12 and pore-forming material 14 depending on the ceramic precursor and pore-forming materials chosen. Mixture 10 generally contains ceramic precursor 12 at a concentration between about 10% by weight and about 90% by weight and contains pore-forming material 14 at a concentration between about 10% by weight and about 90% by weight. The volume fraction of pore-forming material 14 in mixture 10 can vary from about 40% to about 95%. In some embodiments, mixture 10 is compressed after it has been formed to pack ceramic precursor particles 12 and pore-forming material 14 together.

Once mixture 10 has been formed, and optionally compressed, mixture 10 is heated to oxidize ceramic precursor 12 and vaporize pore-forming material 14. Depending on the ceramic precursor and pore-forming material chosen, mixture 10 is generally heated to a final target temperature between about 900° C. and about 1500° C. Mixture 10 can be heated in a tube furnace or other appropriate heating device. In some embodiments, the temperature of the furnace or heating device is raised gradually (e.g., at a rate of about 4-5° C. per minute) until the final target temperature is reached. Once the final target temperature is reached, mixture 10 is heated until substantially all outer surfaces of the ceramic precursor 12 present in mixture 10 has been oxidized. For final target temperatures between about 900° C. and about 1500° C., oxidation is generally substantially complete after between about 3 hours and about 40 hours. In some embodiments, mixture 10 is heated to between about 1400° C. and about 1500° C. for between about 3 hours and about 6 hours. Unlike other porous ceramic production methods, complex controlled heating programs are not needed.

Pore-forming material 14 oxidizes and/or vaporizes during the heating step. Depending on the pore-forming material chosen, the temperature at which oxidation and/or vaporization occurs will differ. For example, PE will vaporize at a lower temperature than graphite and molybdenum oxide. As pore-forming material 14 oxidizes and/or vaporizes, pore-forming material 14 leaves mixture 10 as shown in FIG. 1B. Once pore-forming material 14 has left mixture 10, oxygen is free to diffuse into the region previously occupied by the now vaporized pore-forming material 14. The elevated temperature and presence of oxygen cause ceramic precursor 12 to oxidize, forming oxide layer 16 on the outer surface of ceramic precursor 12. As oxide layer 16 grows, particles of ceramic precursor 12 rearrange to partially close the voids left by the vaporization of pore-forming material 14. Eventually, substantially all of ceramic precursor 12 can be oxidized as shown in FIG. 1C. In other embodiments, only the outer surfaces of ceramic precursor 12 are fully oxidized and part of the core remains unoxidized. Extended exposure to elevated temperature causes metal oxides 22 to sinter and form porous ceramic 18 that contains both pores 20 and metal oxides 22. The sintering process causes additional rearrangement of metal oxide particles 22 to form the final form of porous ceramic 18 having pores 20 and metal oxides 22.

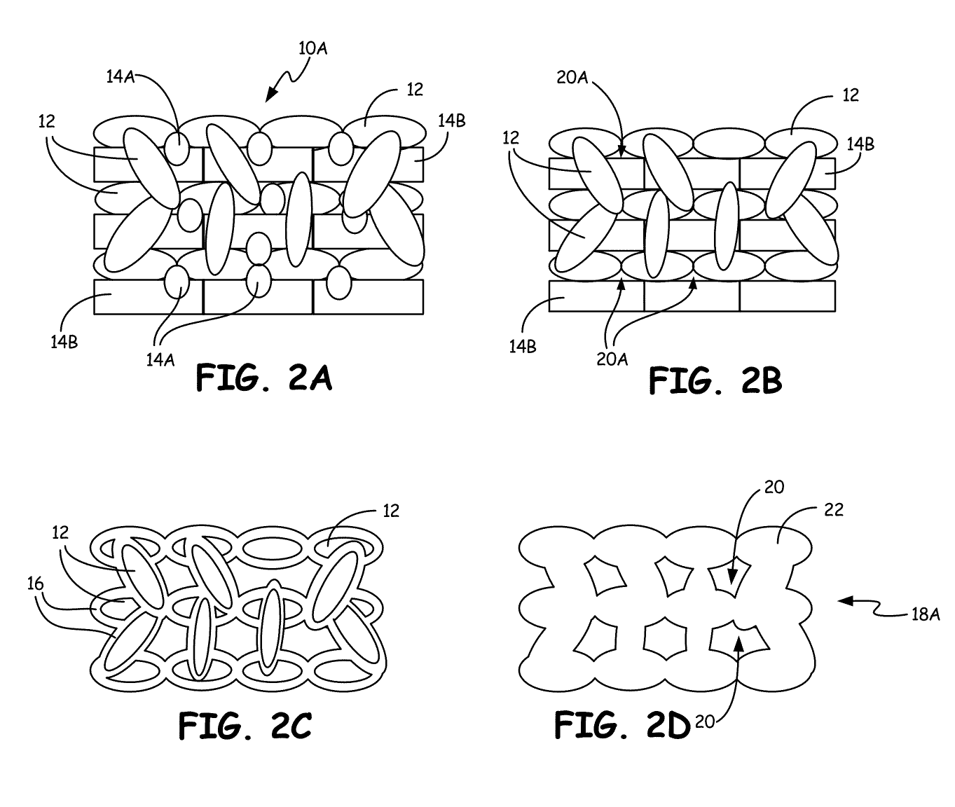

In some embodiments, mixture 10 includes two or more different pore-forming materials 14. FIGS. 2A-2D schematically illustrate one embodiment of a method for forming a porous ceramic in which two different pore-forming materials are used. As shown in FIG. 2A, mixture 10A contains ceramic precursor 12, first pore-forming material 14A and second pore-forming material 14B. Mixture 10A can be compressed to pack ceramic precursor 12, first pore-forming material 14A and second pore-forming material 14B together. First pore-forming material 14A oxidizes and/or vaporizes at a lower temperature than second pore-forming material 14B. In one embodiment, first pore-forming material 14A is PE and second pore-forming material 14B is graphite.

Mixture 10A is heated as described above. Because first pore-forming material 14A oxidizes and/or vaporizes at a lower temperature than second pore-forming material 14B, first pore-forming material 14A is removed from mixture 10A before second pore-forming material 14 as shown in FIG. 2B. Pores 20A are formed where first pore-forming material 14A was present within mixture 10A. As the temperature increases, second pore-forming material 14B also oxidizes and/or vaporizes and oxide layer 16 forms on ceramic precursor 12 as shown in FIG. 2C. Eventually, substantially all of ceramic precursor 12 is oxidized and porous ceramic 18A is formed having pores 20 as shown in FIG. 2D. In other embodiments, only the outer surfaces of ceramic precursor 12 are fully oxidized and part of the core remains unoxidized. By using both first pore-forming material 14A and second pore-forming material 14B in the formation of porous ceramic 18A, the porosity of porous ceramic 18A and the shapes of pores 20 can be tuned.

In some embodiments, mixture 10 includes two or more different ceramic precursors 12. Using different ceramic precursors 12 to form porous ceramic 18 enables the synthesis of new combinations of metals. For example, titanium and iron can be used as ceramic precursors 12 to form a FeTiO₃ porous ceramic and titanium and nickel can be used as ceramic precursors 12 to form TiO₂ and NiTiO₃.

In some embodiments, additional materials can be premixed with ceramic precursors 12 so that porous mixed oxides are generated. Hydroxides, carbonates and oxides can be mixed with ceramic precursors 12 prior to or during the formation of mixture 10. Suitable hydroxides include, but are not limited to, NaOH, Ca(OH)₂ and Mg(OH)₂. Suitable carbonates include, but are not limited to, CaCO₃, Na₂CO₃ and MgCO₃. Suitable oxides include, but are not limited to, alkali metal oxides, alkaline earth metal oxides and oxides of titanium, vanadium, chromium, iron, cobalt, nickel, copper, zinc, zirconium, niobium, tantalum, hafnium, tungsten, aluminum and silicon. These additional materials provide porous ceramics 18 having combinations of different metal oxides. Some of these combinations are difficult to obtain by other means. For example, alkali metals and alkaline earth metals are unstable on their own, but combining oxides of alkali metals and alkaline earth metals with oxides of transitional metals yield porous ceramics 18 having interesting properties.

A number of properties of porous ceramic 18, including porosity, average pore size, relative density, shrinkage and compressive strength can be tuned based on the types of ceramic precursor 12 and pore-forming material 14 selected, the final target temperature, the duration of treatment at elevated temperature, and the presence of any additional materials. The porosity of porous ceramic 18 formed according to the present invention can range from about 50% to about 85%. By varying the size of pore-forming material 14, one can vary the size of pores 20 within porous ceramic 18. According to International Union of Pure and Applied Chemistry (IUPAC) definitions, micropores have widths smaller than 2 nm, mesopores have widths between 2 nm and 50 nm, and macropores have widths larger than 50 nm. The average pore size of pores 20 within porous ceramics 18 can vary between about 2 nm and about 5000 μm. In some embodiments, the average pore size of pores 20 is between about 100 μm and about 1000 μm. The transverse compressive strength observed for porous ceramic 18 can range from about 0.5 MPa to about 14 MPa. The longitudinal compressive strength observed for porous ceramic 18 can range from about 0.3 MPa to about 6.5 MPa. The Examples that follow demonstrate the effect that the types of ceramic precursor 12 and pore-forming material 14 selected, the final target temperature, and the duration of treatment at elevated temperature have on the formed porous ceramics 18.

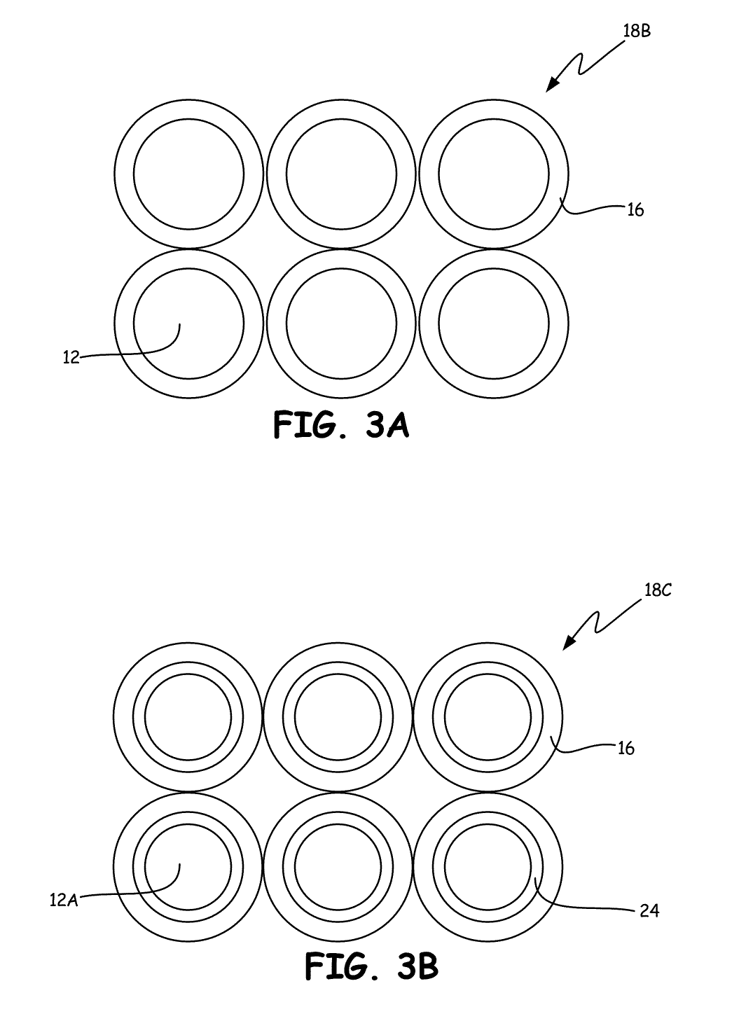

FIGS. 3A and 3B schematically illustrate additional examples of porous ceramics 18. Porous ceramic 18B shown in FIG. 3A includes metal core 12 and oxide layer 16. As shown in FIG. 3A, metal core 12 is unoxidized ceramic precursor. In other embodiments, such as those shown in FIGS. 1C and 2D, substantially all of ceramic precursor 12 is oxidized. Depending on the powder chosen, metal core 12 can be replaced by a carbide core or a nitride core. Porous ceramic 18C shown in FIG. 3B includes ternary carbide core 12A, intermediate layer 24 and outer oxide layer 16. Some ternary carbides form an intermediate layer between the core and outer oxide layer. For example, Ti₃SiC₂ can be selected as ceramic precursor 12. When Ti₃SiC₂ is heated to a temperature sufficient to oxidize Ti₃SiC₂, an intermediate layer of SiO₂ and TiO₂ naturally forms between the core and the outer oxide layer (primarily only TiO₂).

### EXAMPLES

Table 1 illustrates the amounts of ceramic precursors and pore-forming materials used in the samples prepared and tested. V_{fp} refers to the volume fraction of the pore-forming material within a mixture.

TABLE 1

| Composition | Ti (g) | Ni (g) | PE (g) | Graphite (g) | V_{fp} (%) |
|---|---|---|---|---|---|
| A (control) | 3.5 | — | — | — | — |
| B | 3.5 | — | 0.5 | — | 44 |
| C | 3.5 | — | 0.5 | 1.5 | 61 |
| D | 3.5 | — | 0.5 | 7 | 82 |
| E | 1.75 | — | 0.25 | 7 | 90 |
| F | 1.75 | — | 0.25 | 14 | 94 |
| G | 1.75 | 1.24 | 0.5 | 1.5 | 69 |

### Compositions A and B

3.5 grams of titanium (obtained from Alfa Aesar, Ward Hill, Mass.) was mixed with 0.5 grams of polyethylene (obtained from Sigma Aldrich, St. Louis, Mo.) in a ball mill (8000 M mixer mill, SPEX SamplePrep, Metuchen, N.J.) for 5 minutes. The mixtures were cold pressed using a laboratory press (Model 3853, Carver Inc., Wabash, Ind.) at a pressure of about 86 MPa. The pressed mixture was heated in a tube furnace (Model GSL-1100 X, MTI Co., Richmond, Calif.) at a rate of 5° C./min to 900° C. A control sample of pure Ti powder (no PE) was also prepared as described above.

### Compositions C, D, E, F and G

Table 2 illustrates additional test parameters and some of the results obtained from the formed porous ceramics. In Table 2, the calculated porosity was corrected for those samples containing unreacted carbon.

TABLE 2

| | | | Compressive Strength | | | | Unreacted |
|---|---|---|---|---|---|---|---|
| | Temperature, | Porosity | (MPa) | | Shrinkage (%) | | Carbon |
| Composition | Time | (P) | Transverse | Longitudinal | Transverse | Longitudinal | (vol %) |
| C | 1200° C., 4 h | 67 | 3.17 | 1.69 | 4.3 | 34 | 0 |
| | 1400° C., 4 h | 65 | 4.64 | 4.34 | 4.3 | 25 | 0 |
| | 1450° C., 4 h | 64 | 4.41 | 3.29 | 3.9 | 21 | 0 |
| | 1450° C., 8 h | 62 | 9.13 | 4.97 | 3 | 16 | 0 |
| | 1450° C., 15 h | 60 | 8.67 | 5.67 | 2.6 | 16 | 0 |
| | 1500° C., 4 h | 56 | 11.33 | 4.1 | −5 | 19 | 0 |
| D | 1400° C., 4 h | 77 | 1.82 | 0.4 | 0 | 17 | 6 |
| | 1500° C., 4 h | 73 | 6.77 | 2.09 | −5.9 | 5 | 0 |
| | 1450° C., 4 h | 75 | 3.27 | 0.58 | −1.5 | 9 | 7 |
| E | 1400° C., 4 h | 82.5 | 0.77 | 0.47 | −6.2 | 14 | 14 |
| | 1450° C., 4 h | 81 | 3.27 | 0.93 | −7.4 | 5 | 10 |
| | 1500° C., 4 h | 68 | — | — | −14 | −1 | 12 |
| F | 1400° C., 4 h | 84 | 2.2 | 0.75 | −14 | −1 | 29 |
| | 1450° C., 4 h | 81 | — | — | −21 | −1 | 28 |
| | 1500° C., 4 h | 74 | — | — | −31 | −15 | 21 |
| G | 1450° C., 4 h | 62 | 7.7 | 2.8 | 0.2 | 8.4 | 0 |

The amount of ceramic precursor (Ti and Ni, obtained from Alfa Aesar, Ward Hill, Mass.) indicated in Table 1 was mixed with the amount of pore-forming material (PE and graphite, obtained from Sigma Aldrich, St. Louis, Mo.) indicated in Table 1 in a ball mill for 5 minutes. The mixtures were cold pressed using a laboratory press at a pressure of about 86 MPa. The pressed mixture was heated in a tube furnace at a rate of 4° C./min to the temperature listed in Table 2. The sample was kept at the listed temperature for the amount of time indicated in Table 2.

The porous ceramics obtained were evaluated. Weight and dimensions were measured before and after heat treatment. The dimensions of the samples were measured using a Vernier caliper. Positive shrinkage values in Table 2 reflect expansion while negative values indicate shrinkage. X-ray diffraction (XRD) patterns were collected from 10-90° (2) with a 0.02° step size and 1 second count time using a Rigaku Ultima IV X-ray Diffractometer (obtained from Rigaku Americas, The Woodlands, Tex.) with Cu—Ka radiation operated at 40 kV and 44 mA. Compressive strengths were measured using an AG-50 Universal Testing Machine (obtained from Shimadzu) at a deflection rate of 1 mm/min. Reported compressive strengths are the average of at least 3 samples. The transverse direction is perpendicular to the direction mixture 10 was compressed, and the longitudinal direction is parallel to the direction mixture 10 was compressed. The microstructure of the samples was studied using a Hitachi S-3400 N scanning electron microscope (SEM, obtained from Hitachi, Schaumburg, Ill.).

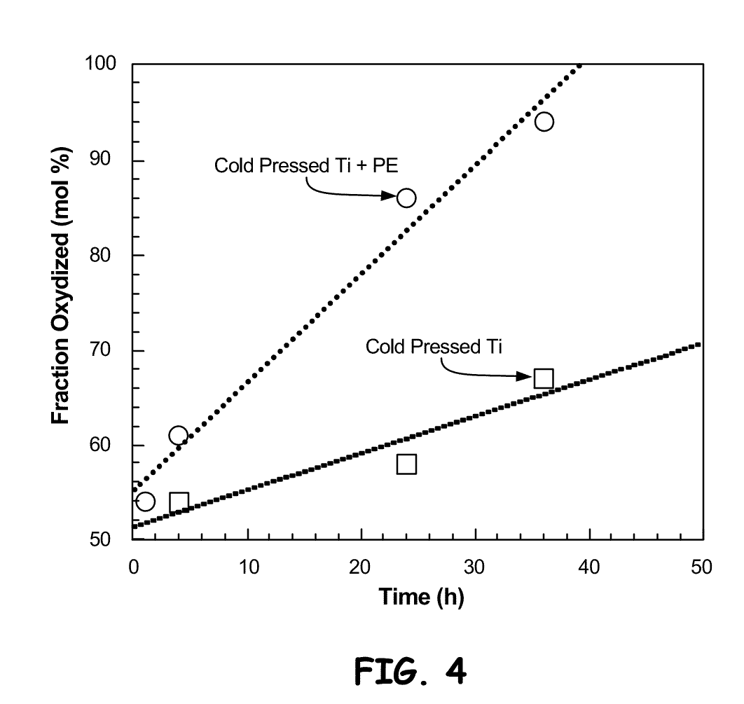

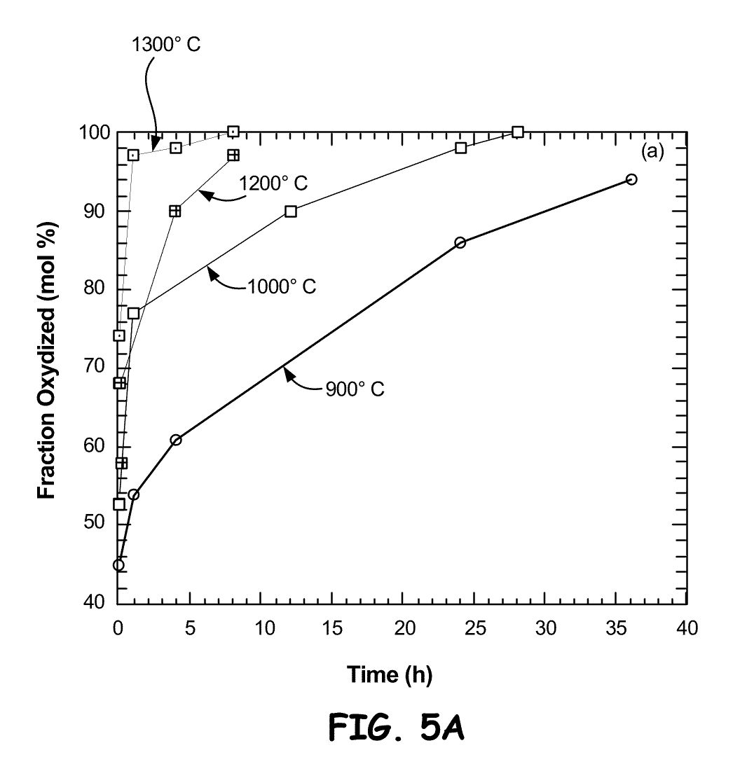

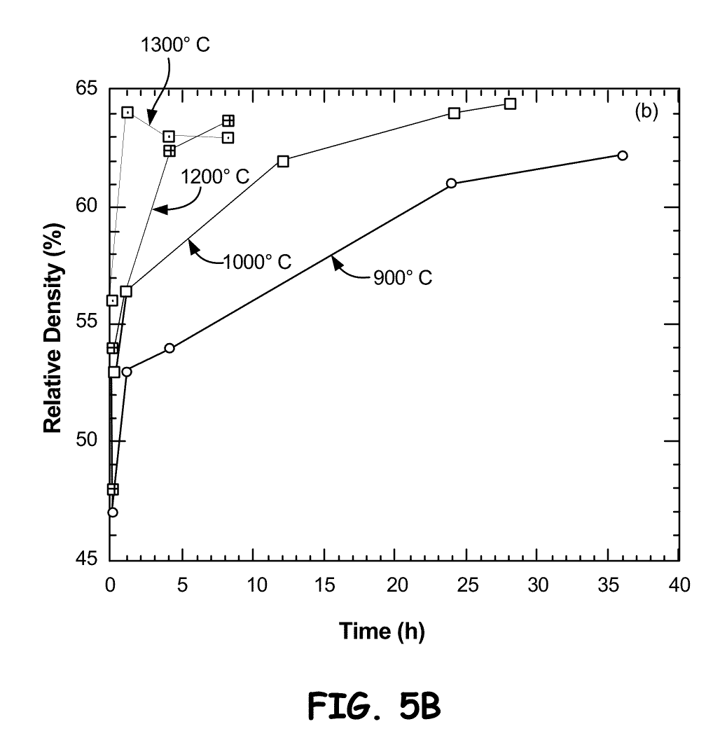

FIG. 4 is a graph illustrating a comparison of the oxidation kinetics of composition A (control sample) and composition B (Ti and PE mixture). While the oxidation kinetics for both samples was linear, the rate of oxidation of the porous ceramic (composition B) was faster than that of the control sample. The presence of the pores formed by the vaporization of PE increased the rate of oxidation. FIGS. 5A and 5B are graphs illustrating oxidation kinetics and relative density, respectively, of composition B mixtures at varying temperatures and times. FIG. 5A demonstrates that Ti and PE mixtures can be completely oxidized in about 28 hours at 1000° C. and in about 8 hours at 1300° C. FIG. 5B demonstrates that the relative density of the formed porous ceramics approach around 64% upon complete oxidation regardless of temperature. The compressive strengths of samples prepared at 1000° C. and 1300° C. were similar at 3.2±0.5 MPa and 3.4±0.8 MPa, respectively. FIG. 6 is an SEM image of composition B produced after 24 hours at 1000° C., showing a homogeneous microstructure having uniformly distributed macropores. Thus, the data for composition B demonstrate the ability to form a porous ceramic using titanium powder and PE.

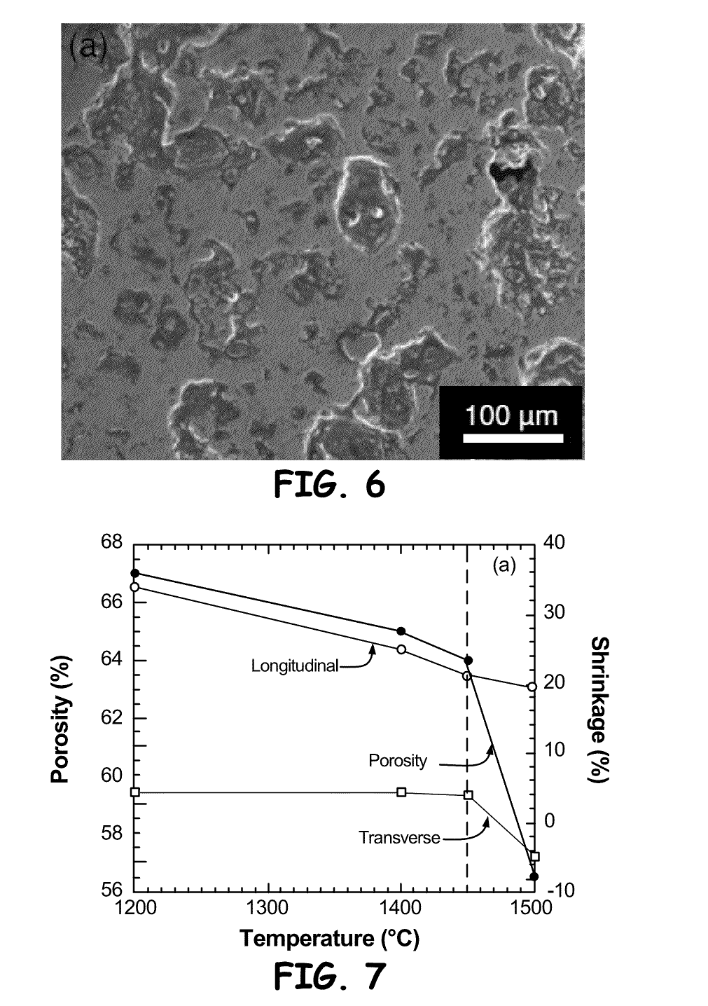

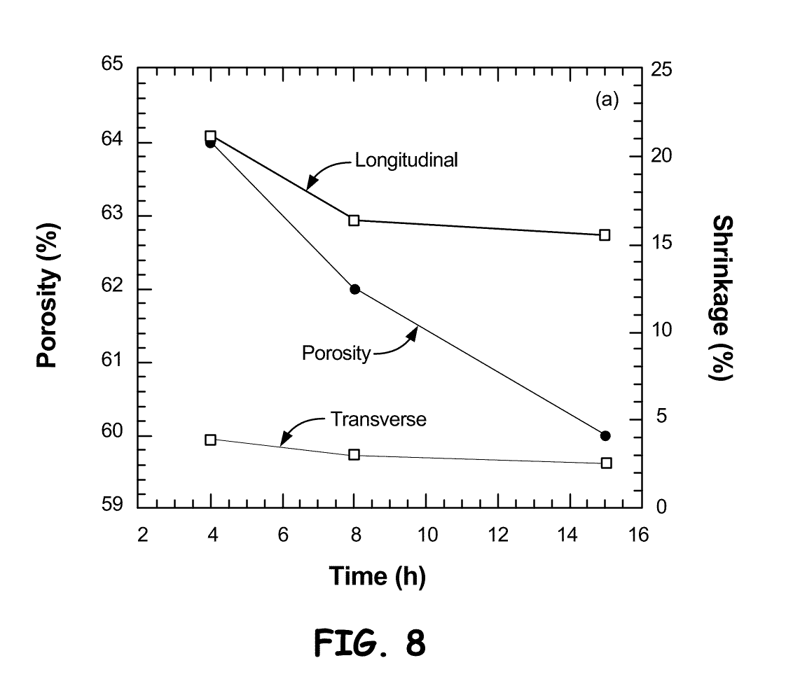

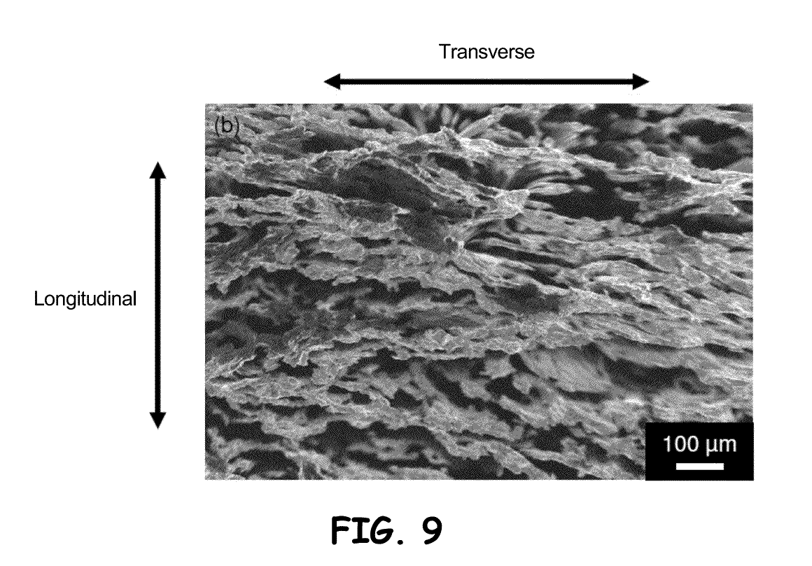

FIG. 7 is a graph illustrating porosity and shrinkage of composition C (Ti, PE and graphite) treated at various temperatures. Longitudinal and transverse shrinkage gradually changed linearly as temperature increased until 1450° C. where the transverse shrinkage changed dramatically. Porosity gradually decreased as temperature increased until 1450° C. where the porosity decreased dramatically. Compressive stress testing showed that samples were generally stronger in the transverse direction as compared to the longitudinal direction at all temperatures tested. FIG. 8 is a graph illustrating porosity and shrinkage of composition C treated at 1450° C. at different time intervals. The porosity gradually decreased over time, indicating that sintering was taking place. As shown in Table 2, the compressive strength of porous ceramics generally increased as treatment temperature increased. FIG. 9 is an SEM image of a cross-section of composition C produced after 4 hours at 1450° C., showing that the graphite leaves behind anisotropic pores that are oriented parallel to the transverse direction. XRD results demonstrated that all of the oxides formed were predominantly rutile. For composition G, XRD results also showed an additional NiTiO₃ phase in addition to TiO₂.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A method for forming a porous ceramic, the method comprising:
forming a mixture comprising:
at least one ceramic precursor; and
at least one pore-forming material;
heating the mixture to oxidize the ceramic precursor and vaporize the pore-forming material.

2. The method of claim 1, wherein the at least one ceramic precursor is selected from the group consisting of titanium, vanadium, chromium, iron, cobalt, nickel, copper, zinc, zirconium, niobium, tantalum, hafnium, tungsten, aluminum, silicon and combinations thereof.

3. The method of claim 2, wherein the at least one ceramic precursor is an alloy.

4. The method of claim 1, wherein the at least one ceramic precursor is a carbide.

5. The method of claim 4, wherein the at least one ceramic precursor is a carbide selected from the group consisting of TiC, SiC, TaC, ZrC and combinations thereof.

6. The method of claim 1, wherein the at least one ceramic precursor is a nitride.

7. The method of claim 6, wherein the at least one ceramic precursor is a nitride selected from the group consisting of TiN, Si₃N₄ and combinations thereof.

8. The method of claim 1, wherein the at least one ceramic precursor is a MAX phase compound.

9. The method of claim 8, wherein the at least one ceramic precursor is a MAX phase compound selected from the group consisting of Ti₃SiC₂, Ti₂AlC, Cr₂AlC, V₂AlC, Ti₂AlN, Nb₂AlC, Ti₄AlN₃ and combinations thereof.

10. The method of claim 1, wherein the mixture further comprises:
a second ceramic precursor different from the first ceramic precursor.

11. The method of claim 1, wherein the at least one pore-forming material is selected from the group consisting of graphite, molybdenum oxides, polymers that decompose or oxidize to form one or more gases at temperatures above 200° C., and combinations thereof.

12. The method of claim 11, wherein the at least one pore-forming material is polyethylene.

13. The method of claim 1, wherein the mixture further comprises:
a second pore-forming material different from the first pore-forming material.

14. The method of claim 1, wherein the mixture is heated to a temperature between 900° C. and 1500° C.

15. The method of claim 14, wherein the mixture is heated to a temperature between 1400° C. and 1500° C.

16. The method of claim 1, wherein heating the mixture for between 4 hours and 40 hours oxidizes substantially all outer surfaces of the ceramic precursor.

17. The method of claim 15, wherein heating the mixture for between 3 hours and 6 hours oxidizes substantially all outer surfaces of the ceramic precursor.

18. The method of claim 1, wherein the porous ceramic comprises a plurality of pores having an average pore size, and wherein the average pore size decreases as the mixture is heated.

19. The method of claim 1, wherein the mixture further comprises:
an additional material selected from the group consisting of hydroxides, carbonates, oxides and combinations thereof.

20. The method of claim 19, wherein the additional material is selected from the group consisting of NaOH, Ca(OH)₂, Mg(OH)₂, alkali metal oxides, alkaline earth metal oxides, CaCO₃, Na₂CO₃, MgCO₃ and combinations thereof.

21. The method of claim 1, wherein the method further comprises:
compressing the mixture prior to heating.

22. The method of claim 1, wherein the porous ceramic comprises:
a core; and
an outer oxide layer.

23. The method of claim 22, wherein the porous ceramic further comprises:
an intermediate oxide layer located between the core and the outer oxide layer, wherein the intermediate oxide layer is different from the outer oxide layer.
